(19) United States
(12) Patent Application Publication
(10) Pub. No.: US 2025/0286675 A1
(43) Pub. Date: Sep. 11, 2025

(54) SIMULTANEOUS MULTI-PANEL UPLINK DATA TRANSMISSION

(71) Applicant: InterDigital Patent Holdings, Inc., Wilmington, DE (US)

(72) Inventors: Loic Canonne-Velasquez, Dorval (CA); Afshin Haghighat, Ile-Bizard (CA); Jonghyun Park, Syosset, NY (US); Virgil Comsa, Montreal (CA); Moon IL Lee, Melville, NY (US)

(73) Assignee: InterDigital Patent Holdings, Inc., Wilmington, DE (US)

(21) Appl. No.: 18/858,645

(22) PCT Filed: Apr. 21, 2023
(86) PCT No.: PCT/US2023/019436

§ 371 Date: Oct. 21, 2024

Related U.S. Application Data
(60) Provisional application No. 63/334,874, filed on Apr. 26, 2022.
(60) Provisional application No. 63/394,808, filed on Aug. 3, 2022.

(51) Int. Cl. H04L 5/00

(52) U.S. Cl. CPC H04L 5/0044; H04L 5/0048

(57) ABSTRACT

A wireless transmit/receive unit (WTRU) may receive configuration information that indicates a first SRS resource set and a second SRS resource set. The WTRU may receive first DCI comprising a first UL grant. The first DCI may include a first indication to transmit with multiple panels simultaneously. The first DCI may include a second indication associating each of the multiple panels with a respective one of the first or second SRS resource sets for the first UL grant. The second indication may indicate that the first SRS resource set is to be used for first transmission using the first panel and the second SRS resource set is to be used for a second transmission using the second panel, or vice versa. The WTRU may simultaneously transmit the first transmission via the first panel and the second transmission via the second panel, in accordance with the first and second indications.

### CROSS-REFERENCE TO RELATED APPLICATIONS

This application claims priority to U.S. Provisional Application No. 63/334,874, filed on Apr. 26, 2022, and U.S. Provisional Application No. 63/394,808, filed on Aug. 3, 2022, the entireties of which are incorporated herein by reference.

### BACKGROUND

Mobile devices can communicate wirelessly, for example over cellular networks. Mobile devices can also communicate with multiple transmission/reception points by transmitting and receiving from one or more panels. Generally, the term panel may be used to refer to one or more antenna(s) and/or one or more antenna array(s) used for transmission and/or reception. Transmission and reception between devices (e.g., mobile devices) with multiple panels and transmission/reception points can be improved. The techniques described herein include methods and systems for communicating between devices having multiple panels for transmitting and receiving and transmission/reception points.

### SUMMARY

The present disclosure relates generally to a devices, methods, and systems for wireless communications. More specifically, the present disclosure relates to using multiple panels for uplink of transmission data. For instance, the disclosure provides, among other things, a wireless transmit receive unit (WTRU) configured to dynamically determine subsets of antenna panels for Simultaneous Multi-Panel (SMP) transmission. The WTRU may be configured to dynamically select antenna ports for non-SMP and SMP modes of operation. The WTRU may be configured to send a Random Access Channel (or procedure) (RACH) with SMP as a function of preamble indices. The WTRU may be configured to determine an SMP mode of operation and one or more associated Sounding Reference Signal (SRS) Resource Indicators (SRIs), Transmission/Transmit Precoding Matrix Indicators (TPMIs), and a number of layers per panel. The WTRU may be configured to dynamically select one or more Physical Uplink Shared Channel (PUSCH) scrambling identities as a function of a SMP mode of operation. The WTRU may be configured to apply a power scaling factor when transmitting in SMP.

A wireless transmit receive unit (“WTRU”) may have and/or utilize a plurality of panels (e.g., any number of panels that is more than one) for transmitting and/or receiving with transmission/reception points (TRPs). The WTRU has a processor programmed with executable instructions stored in memory. The executable instructions causing the WTRU to determine to include in an uplink transmission an indication that the WTRU has multiple panels capable of being using for one or modes of simultaneous multi-panel (SMP) transmission. The indication may indicate that the WTRU is capable of sending transmissions may be sent on a physical uplink shared channel (PUSCH) using multiple panels. The WTRU may determine from a downlink transmission that the WTRU has received an indication of whether the WTRU is scheduled for transmission on one or more of the WTRU panels on the PUSCH. The WTRU may determine an SMP mode of operation for transmission on the PUSCH. For example, the WTRU may determine the SMP mode of operation based on one or more explicit indications received in a downlink transmission that schedules the PUSCH transmission (e.g., in a downlink control information (DCI) containing an uplink grant) and/or based on one more preconfigured parameters. The WTRU may determine one or more associated sounding reference signal (SRS) resource indicators (SRIs), one or more associated transmit precoding matrix indicators (TPMIs), and/or a number of layers to use for the transmission based on the determined SMP mode of operation. For example, the WTRU may determine the one or more SRIs, TPMIs, and/or number of layers for each panel to be used for transmission based on the determined SMP mode of operation.

A WTRU processor may be programmed with executable instructions for determining from one or more downlink transmissions a first PUSCH scrambling parameter for the first panel and a second PUSCH scrambling parameter for the second panel. The WTRU may determine the first and/or second PUSCH scrambling parameters based on the determined SMP mode of operation. The WTRU may apply the first scrambling parameter to a PUSCH transmission associated with the first panel and may apply the second scrambling parameter to a PUSCH transmission associated with the second panel.

A WTRU processor may be programmed with executable instructions that adjusts the power of the first and the second panel based on determining a power scaling factor for adjusting the power allocation between the first panel and the second panel. The WTRU may apply the power scaling factor to adjust the power allocation between the first panel and the second panel for transmitting from the first panel and the second panel.

A WTRU may have a first antenna panel, a second antenna panel, and a processor programmed with executable instructions that determine whether to operate in a non-SMP mode of operation or an SMP mode of operation based on received downlink control information from a network. In the non-SMP mode of operation, the WTRU transmits from either the first or the second antenna panel at a first time, and in the SMP mode of operation transmits from the first and the second antenna panel at a second time.

The WTRU may have a processor programmed with executable instructions to determine dynamically a subset of panels for SMP transmission, to determine dynamically to select antenna ports for non-SMP and SMP modes of operation, and/or to determine to send RACH with SMP based on preamble indices.

A wireless transmit/receive unit (WTRU) may include a processor that is configured to receive configuration information that indicates a first sounding reference signal (SRS) resource set and a second SRS resource set. The WTRU may receive first downlink control information (DCI) comprising a first UL grant. The first DCI may include a first indication to transmit with multiple panels simultaneously. The first DCI may include a second indication associating each of the multiple panels with a respective one of the first or second SRS resource sets for the first UL grant. The second indication may indicate that the first SRS resource set is to be used for first transmission using the first panel and the second SRS resource set is to be used for a second transmission using the second panel. Alternatively, the second indication may indicate that the second SRS resource set is to be used for the first transmission using the first panel and the first SRS resource set is to be used for the second transmission using the second panel. The WTRU may be configured to transmit (e.g., simultaneously transmit) the first transmission via the first panel and the second transmission via the second panel, in accordance with the first and second indications.

In some examples, the configuration information may indicate a first scrambling ID associated with a first panel and/or a second scrambling ID associated with a second panel. The first transmission using the first panel may use a first scrambling sequence determined based on an index of the first panel and the first scrambling ID, and the second transmission using the second panel may use a second scrambling sequence determined based on an index of the second panel and the second scrambling ID. The first scrambling sequence may be initialized with the index of the first panel, and the second scrambling sequence may be initialized with the index of the second panel. In some examples, the first transmission using the first panel may use a first precoder based on a first number of layers associated with the first panel, and/or the second transmission using the second panel may use a second precoder based on a second number of layers associated with the second panel.

In some examples, the first DCI may include a third indication associating a first precoder with a first number of layers and a second precoder with a second number of layers. In some examples, the first SRS resource set may correspond to a first spatial filter, and/or the second SRS resource set may correspond to a second spatial filter. Finally, in some examples, the WTRU may be configured to determine a power scaling factor to adjust the power allocation between the first panel and the second panel, and apply the power scaling factor to adjust the power allocation between the first panel and the second panel.

### BRIEF DESCRIPTION OF THE FIGURES

A more detailed understanding may be had from the following description, given by way of example in conjunction with the accompanying drawings, in which like reference numerals in the figures indicate like elements.

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A.

FIG. 1C is a system diagram illustrating an example radio access network (RAN) and an example core network (CN) that may be used within the communications system illustrated in FIG. 1A.

FIG. 1D is a system diagram illustrating a further example RAN and a further example CN that may be used within the communications system illustrated in FIG. 1A.

FIG. 2 is an example of simultaneous multi-panel (SMP) mode of operation for two transmission/reception points.

FIG. 3 is an example panel selection table.

FIG. 4 is an example panel selection table for two repetitions.

FIG. 5 is an example antenna port indication table.

FIG. 6 is an example DMRS port indication table.

FIG. 7 is a table illustrating an example dynamic switching of non-SMP and SMP.

FIG. 8 is an example diagram that illustrates a WTRU and a network element that are configured in accordance with an example configuration of the above described features.

### DETAILED DESCRIPTION

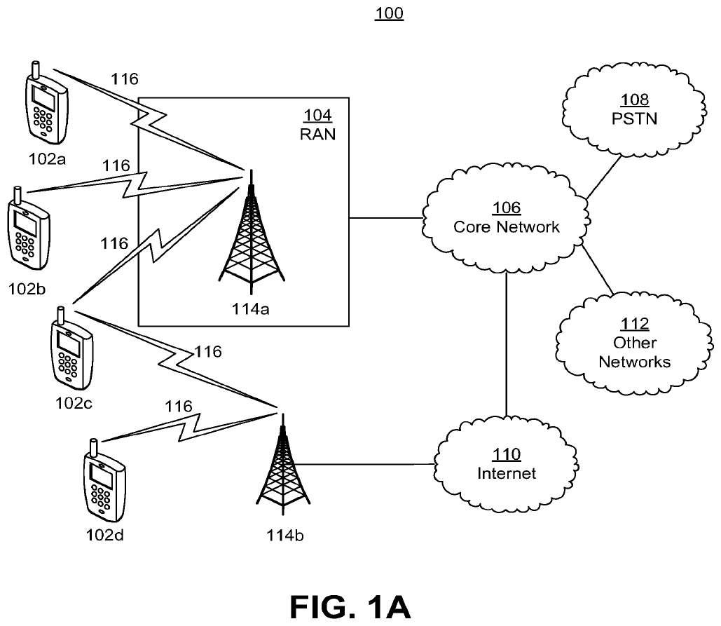

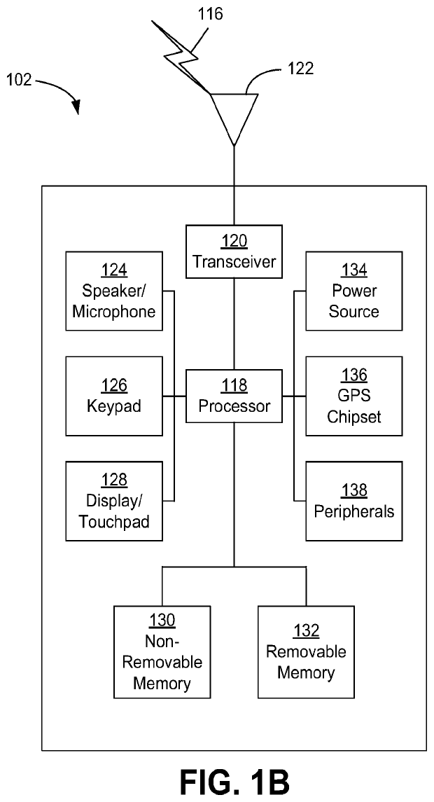

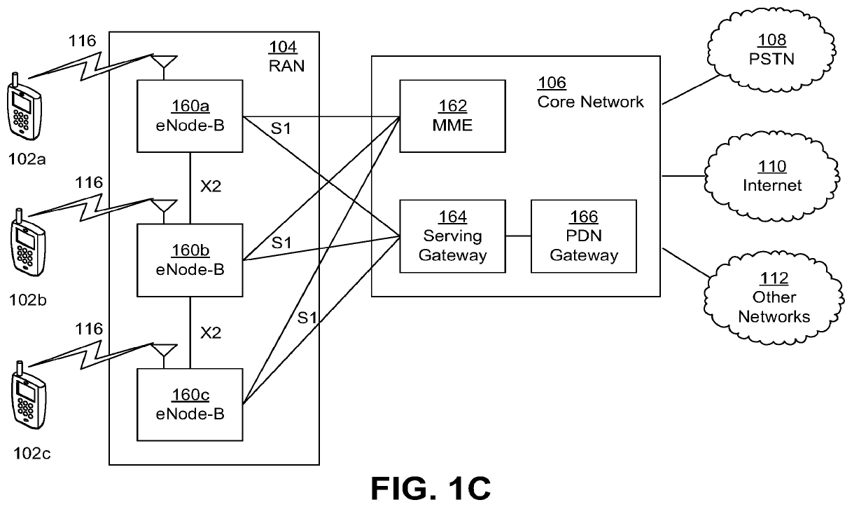

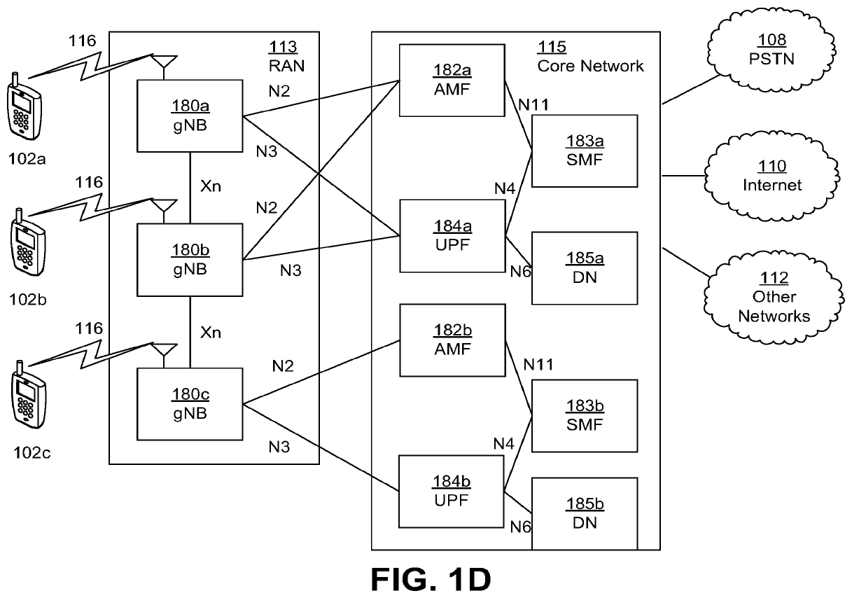

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscopes, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily, or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHZ, 4 MHZ, 8 MHZ, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Unless otherwise stated, “a” and “an” and similar phrases are to be interpreted as “one or more” and “at least one.” Unless otherwise stated, any term which ends with the suffix “(s)” is to be interpreted as “one or more” and “at least one.” The term “may” is to be interpreted as “may, for example.”

The following abbreviations and acronyms, among others, are used herein: Component Carrier (CC); Configured grant (CG); Dynamic grant (DG); MAC control element (MAC CE); Acknowledgement (ACK); Block Error Rate (BLER); Bandwidth Part (BWP); Coherent Joint Transmission (C-JT); Cyclic Prefix (CP); Conventional OFDM (relying on cyclic prefix) (CP-OFDM); Channel Quality Indicator (CQI); Cyclic Redundancy Check (CRC); Channel State Information (CSI); Downlink Assignment Index (DAI); Downlink Control Information (DCI); Downlink (DL); Demodulation Reference Signal (DM-RS); Data Radio Bearer (DRB); Frequency Division Duplex (FDD); Hybrid Automatic Repeat Request (HARQ); Long Term Evolution (e.g. from 3GPP LTE R8 and up) (LTE); Negative ACK (NACK); Multiple TRP or multi-TRP (mTRP); Modulation and Coding Scheme (MCS); Multiple Input Multiple Output (MIMO); Non-Coherent Joint Transmission (NC-JT); New Radio (NR); Orthogonal Frequency-Division Multiplexing (OFDM); Physical Layer (PHY); Precoding Matrix Indicator (PMI); Physical Random Access Channel (PRACH); Primary Synchronization Signal (PSS); Physical Uplink Shared Channel (PUSCH); Random Access Channel (or procedure) (RACH); Random Access Response (RAR); Radio Front end (RF); Radio Link Failure (RLF); Radio Link Monitoring (RLM); Radio Network Identifier (RNTI); Radio Resource Control (RRC); Radio Resource Management (RRM); Reference Signal (RS); Reference Signal Received Power (RSRP); Received Signal Strength Indicator (RSSI); Service Data Unit (SDU); Simultaneous Multi-Panel (SMP); SRS Resource Indicator (SRI); Sounding Reference Signal (SRS); Synchronization Signal (SS); Secondary Synchronization Signal (SSS); Semi-persistent scheduling (SPS); Supplemental Uplink (SUL); Single transmission reception point (sTRP); Transport Block (TB); Transport Block Size (TBS); Time-division multiplexing (TDM); Transmission/Transmit Precoding Matrix Indicator (TPMI); Transmission/Reception Point (TRP); Uplink (UL); Ultra-Reliable and Low Latency Communications (URLLC); and Wireless Local Area Networks and related technologies (IEEE 802.xx domain) (WLAN).

The disclosure described herein may be implemented in NR networks or networks supporting multi-transmission/reception points. NR supports multi-TRP (mTRP) uplink transmission of PUSCH repetitions in, for example, TDM mode. A WTRU may transmit multiple copies in different time instances towards different TRPs. Transmitting multiple copies in different time instances towards different TRPs may enhance PUSCH transmission reliability.

There are differences between single (e.g., sTRP) and mTRP for the UL NR PUSCH transmission grant single DCI (e.g., sDCI). For sTRP, there is typically one TPMI indicated (e.g., UL PMI codebook index), one SRI (e.g., UL beam indication), one frequency domain resource allocation (FDRA) and/or time domain resource allocation (TDRA), one set of power control parameters, and one set of DM-RS antenna ports. For mTRP, there may be 2 TPMIs, which may have the same number of layers mapped to repetitions (e.g., cyclical, sequential, and the like); two SRIs mapped to repetitions; one FDRA (e.g., the same for both TRPs), one TDRA, which indicates mapping of TPMIs/SRIs to repetitions; two sets of power control parameters; and one set of DMRS antenna ports.

In NR, WTRUs may be multi-panel WTRUs. A multi-panel WTRU may report its multi-panel capabilities to the network for dynamic panel switching. A WTRU may report a list of WTRU capability values (e.g., sets), which may facilitate WTRU-initiated panel activation and selection. A WTRU capability value set may include the number of SRS ports (e.g., the maximum number of SRS ports). WTRU capability value sets may be different. The WTRU capability value set may be common across BWPs/CCs in the same band.

A WTRU can report an index of WTRU capability value (e.g., set). A WTRU can report an index of WTRU capability value set for each reported CRI/SSBRI in beam reports (e.g., one beam reporting), which can be used for WTRU-initiated panel activation and selection.

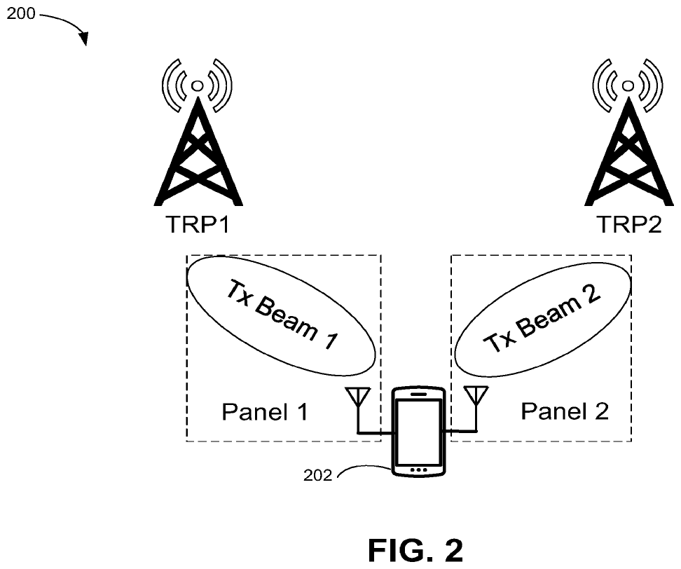

The disclosure herein may include the simultaneous transmission of PUSCH, as illustrated in FIG. 2. FIG. 2 is a diagram of a system 200 that illustrates a simultaneous multi-panel (SMP) mode of operation for two transmission/reception points, for example, TRP1 and TRP2. Although FIG. 2 illustrates two WTRU panels, such as Panel 1 and Panel 2; however, it is understood that a WTRU, such as WTRU 202, may have multiple panels (e.g., any number more than one). The WTRU may use a simultaneous multi-panel UL transmission. The simultaneous multi-panel UL transmission may create higher UL throughput/reliability. For example, throughput/reliability may be improved for Frequency Range 2 (e.g., FR2 such as 24.25 GHz to 52.6 GHZ) and multi-TRP, assuming up to 2 TRPs and up to 2 panels. Example applications include customer premises equipment (CPE) applications, fixed wireless access (FWA) applications, vehicular applications (e.g., V2X, V2V, etc.), industrial devices (e.g., IoT, etc.), and/or the like.

The WTRU may use UL precoding indication for PUSCH. For example, for the cases in which a new codebook is not introduced for multi-panel simultaneous transmission, the WTRU may use UL precoding indication for PUSCH. The number of layers may be up to four across all panels. The number of codewords may be up to two across all panels. The WTRU may determine the number of layers and/or the number of codewords based on a single DCI and multi-DCI based multi-TRP operation.

The WTRU may use an UL beam indication for PUCCH/PUSCH. For example, the WTRU may use the UL beam indication for PUCCH/PUSCH for a unified TCI framework extension. The WTRU may use the UL beam indication for PUCCH/PUSCH for a unified TCI framework extension based on a single DCI and multi-DCI based multi-TRP operation. The WTRU may transmit PUSCH and PUSCH (e.g., PUSCH+PUSCH) or PUCCH and PUCCH (e.g., PUCCH+PUCCH) across two panels, which may be in the same CC. For example, the WTRU may transmit PUSCH+PUSCH or PUCCH+PUCCH across two panels in the same CC for a multi-DCI based multi-TRP operation.

For some applications, a PUSCH cannot be scheduled in, for example, SMP transmission mode. For instance, the WTRU may receive a grant indicating that one (e.g., only one) UL precoder/beam may be used at a time. The WTRU, using, for example, mTRP mode, may not be able to flexibly configure grant parameters as, for example, the grant parameters are limited to the specific application of repetitions for reliability enhancements. The grant parameters may be, for example, but not limited to, TPMI, SRI, FDRA, TDRA, antenna ports, and the like. Further, the WTRU may be limited to using, for example, but not limited to, the same rank for both TRPs, the same resource allocation, the same number of ports. A SMP may generate inter-panel interference due to, for example, overlapping PUSCH transmissions in the same time instance and separate power control procedures. The WTRU's power control on one TRP may be determined without considering other simultaneous transmissions. As such, the disclosure provided herein provides devices, methods, and systems to determine how to send PUSCH in SMP mode of operation, to determine one or more SMP transmission parameters (e.g., TPMI, antenna ports, and the like), and/or to mitigate inter-panel interference.

The WTRU may transmit or receive a physical channel or reference signal. The physical channel or reference signal may be received according to at least one spatial domain filter. The term “beam” may refer to a spatial domain filter.

The WTRU may transmit a physical channel or signal using a spatial domain filter. The spatial domain filter may be the same/similar spatial domain filter to receive an RS (e.g., a CSI-RS) or a SS block. The WTRU transmission may be referred to as “target.” The received RS or SS block may be referred to as a “reference” or “source.” As such, the WTRU may transmit the target physical channel or signal according to a spatial relation with reference to the RS or SS block.

The WTRU may transmit a physical channel or signal according to the same spatial domain filter as the spatial domain filter used for transmitting a second physical channel or signal. The first transmission may be referred to as a “target.” The second transmission may be referred to as a “reference” or “source”. As such, the WTRU may transmit the first (i.e., the target) physical channel or signal according to a spatial relation with a reference to the second (i.e., reference) physical channel or signal.

In one or more cases, a spatial relation may be implicit, configured by RRC, or signaled by MAC CE or DCI. For example, the WTRU may implicitly transmit PUSCH and DM-RS of PUSCH according to the same/similar spatial domain filter as an SRS indicated by an SRS resource indicator (SRI) indicated in DCI or configured by RRC. In another example, the WTRU may configure the spatial relation by RRC for an SRI. In another example, MAC CE may signal the spatial relation for a PUCCH. Spatial relation may also be referred to as a “beam indication.”

The WTRU may receive a (i.e., a target) downlink channel or signal. The downlink channel or signal may be received according to the same/similar spatial domain filter or spatial reception parameter as a second (i.e., a reference) downlink channel or signal. For example, such association may exist between a physical channel (e.g., PDCCH or PDSCH) and its respective DM-RS. When the first and second signals are reference signals, such association may exist when the WTRU is configured with a quasi-colocation (QCL) assumption type D between corresponding antenna ports. The association may be configured as a transmission configuration indicator (TCI) state. The WTRU may receive an indication that includes an association between a CSI-RS or SS block and a DM-RS by an index to a set of TCI states configured by RRC and/or signaled by MAC CE. The indication may also be referred to as “beam indication.”

Unless otherwise stated, RS may be interchangeably used with one or more of RS resource, RS resource set, RS port and RS port group. Unless otherwise stated, RS may be interchangeably used with one or more of SSB, CSI-RS, SRS and DM-RS. Unless otherwise stated, TRP may be used interchangeably used with one or more of TP (transmission point), RP (reception point), RRH (radio remote head), DA (distributed antenna), BS (base station), a sector (of a BS), and a cell (e.g., a geographical cell area served by a BS. Moreover, unless otherwise stated, multi-TRP may be used interchangeably with one or more of MTRP, M-TRP, and multiple TRPs.

In one or more cases, the WTRU may be configured with (or may receive configuration of) one or more TRPs. The WTRU may transmit and/or receive from the one or more TRPs. The WTRU may be configured with one or more TRPs for one or more cells. A cell may be, for example, a serving cell and/or a secondary cell.

The WTRU may be configured with at least one RS. The RS may be for channel measurement. The RS may be denoted as a Channel Measurement Resource (CMR). The RS may include a CSI-RS, SSB, and/or other downlink RS. The CSI-RS, SSB, and/or other downlink RS may be transmitted from the TRP to the WTRU. A CMR may be configured or associated with a TCI state. The WTRU may be configured with a CMR group. The CMR group may include one or more CMR indices. The CMR group with the one or more CRI indices may be transmitted from the same TRP. A CMR group may be identified by a CMR group index (e.g., group 1). The WTRU may be configured with a CMR group per TRP. The WTRU may receive from a TRP a linkage between one CMR group index and another CMR group index and/or between one RS index from one CMR group and another RS index from another group. The WTRU may determine that linked resources may be configured for C-JT MTRP channel or CSI measurements. The WTRU may determine the linked resources from the received TRP transmissions.

The WTRU may be configured with (or receive configuration of) one or more pathloss (PL) reference groups (e.g., sets) and/or one or more SRS groups, SRS resource indicator (SRI) or SRS resource sets. A PL reference group may correspond to or may be associated with a TRP. The PL reference group may include, identify, correspond to or be associated with one or more TCI states, SRIs, reference signal sets (e.g., CSI-RS set, SRI sets), CORESET index, and/or reference signals (e.g., CSI-RS, SSB).

The WTRU may receive a configuration (e.g., any configuration described herein). The configuration may be received from a TRP or a gNB. For example, the WTRU may receive a configuration (e.g., configuration information) of one or more TRPs, one or more PL reference groups, and/or one or more SRI sets. The WTRU may implicitly determine an association between a RS set/group and a TRP. For example, for the cases in which the WTRU is configured with two SRS resource sets, the WTRU may determine to transmit to TRP1 with SRS in the first resource set, and to TRP2 with SRS in the second resource set. The WTRU may be configured to transmit the resource sets via RRC signaling.

The WTRU may receive an indication of a primary and secondary TRP. The WTRU may determine that one of the TRPs is the primary or anchor TRP based on, for example, the WTRU being configured with multiple TRPs. In one or more cases, the WTRU may determine the primary or anchor TRP based on a network configuration. In one or more cases, the WTRU may determine the primary or anchor TRP by determining that a received signal quality for one TRP is above all other TRP's received signal quality or above a threshold signal quality. The WTRU may make determine the primary or anchor TRP by comparing the received signal quality for one or more TRPs and/or comparing a received signal quality to a threshold signal quality. The threshold signal quality may be predetermined and/or stored in WTRU memory.

Unless otherwise stated, TRP, PL reference group, SRI group, and SRI set may be used interchangeably. Unless otherwise stated, the terms set and group may be used interchangeably.

A joint transmission system with two TRPs is described as an example. However, it is understood that any number of TRPs can be used. In the example described, one TRP is considered the primary TRP.

A property of a grant or assignment may include one or more of: a frequency allocation; an aspect of time allocation (e.g., duration); a priority; a modulation and/or coding scheme; a transport block size; a number of spatial layers; a number of transport blocks; a TCI state, a CRI and/or SRI; a number of repetitions; a determination of whether the repetition scheme is Type A or Type B; a determination of whether the grant is a configured grant type 1, type 2 or a dynamic grant; a determination of whether the assignment is a dynamic assignment or a semi-persistent scheduling (configured) assignment; a configured grant index or a semi-persistent assignment index; a periodicity of a configured grant or assignment; a channel access priority class (CAPC); any parameter provided in a DCI, MAC, and/or RRC, a determination of whether the grant is for single-TRP transmission or multi-TRP transmission; a determination of whether the grant is for UL transmission from single WTRU panel (TxSP) or simultaneous UL transmission from multiple WTRU panels (STxMP); and/or a determination of whether the grant is for C-JT or NC-JT transmission. In an example, the TCI state, CRI, or SRI may be for each WTRU panel, for example, for the cases in which multiple panels are used for a UL transmission. The parameter provided in a DCI, MAC, and/or RRC may be used for scheduling the grant or assignment.

The WTRU may report a subset of channel state information (CSI) components. The CSI components may correspond to one or more of a CSI-RS resource indicator (CRI); a SSB resource indicator (SSBRI); an indication of a panel used for reception at the WTRU; measurements such as L1-RSRP, L1-SINR taken from SSB or CSI-RS; and/or other channel state information. The indication of a panel used for reception at the WTRU may be, for example, but not limited to, a panel identity or group identity. The measurements such as L1-RSRP, L1-SINR taken from SSB or CSI-RS may be, for example, but not limited to, cri-RSRP, cri-SINR, ssb-Index-RSRP, ssb-Index-SINR, and the like. The other channel state information may be, for example, but not limited to, one or more of a rank indicator (RI), channel quality indicator (CQI), precoding matrix indicator (PMI), layer index (LI), and the like.

The WTRU may be configured with a scrambler. In the uplink, the WTRU may transmit data through the PUSCH. As part of the UL processing, the WTRU may determine to send one Transport Block (TB). The TB may be channel coded with a low-density parity check (LDPC) encoder. The TB may be rate matched to obtain a target coding rate. The WTRU may apply a scrambler to the coded bits prior to modulation. For example, after rate matching, the WTRU may apply the scrambler to the coded bits prior to the modulation. The WTRU may determine the scrambler according to a scrambling sequence. The scrambling sequence may be generated based on an initial seed, for example, c_init. The WTRU may determine the seed as a function of a parameter (e.g., dataScramblingIdentityPUSCH). The function of the parameter may be configured in the PUSCH. The seed may be a function of the RNTI. For example, the seed may be a function of the RNTI associated to the PUSCH (e.g., C-RNTI), as shown in the following equation:

$${c}_{init} = \{ \begin{matrix}{n}_{RNTI} \cdot {2}^{16} + {n}_{RAPID} \cdot {2}^{10} + {n}_{ID} & for msgA on PUSCH \\ {n}_{RNTI} \cdot {2}^{15} + {n}_{ID} & otherwise\end{matrix}$$

n_ID may be equal to the dataScramblingIdentityPUSCH value. The dataScramblingIdentityPUSCH value may be taken from the range of integers {0, . . . , 1023}.

The WTRU my receive an indication of an SMP mode of operation. For a codebook-based uplink transmission, the WTRU may receive an indication of precoding information. For example, the WTRU may receive the indication with precoding information according to its transmission channel. For the cases in which the WTRU has multiple panels, the WTRU may receive independent indications for each panel that is activated for a transmission. Per TRP TPMI indication, the WTRU may provide a PUSCH repetition for uplink reliability improvements.

The WTRU may determine the SMP mode of operation for PUSCH. The WTRU may indicate its multi-panel uplink transmission capability. For example, WTRU may indicate its multi-panel uplink transmission capability by reporting the number of panels, number of SRS ports per panel, and/or coherence capability per panel.

For example, the WTRU may indicate its multi-panel transmission capability. The WTRU may receive an explicit or implicit indication of whether the WTRU will be scheduled for transmission using one or both panels. The WTRU may receive the explicit or implicit indication in response to the WTRU indicating its multi-panel transmission capability. In one or more cases, the WTRU may report WTRU capability. the WTRU may receive an indication to use a codebook per panel. The WTRU may receive the indication to use a codebook per panel based on the WTRU reporting WTRU capability. In an example, the WTRU may report a 2 port SRS capability on one panel, and a 4 port SRS capability on another panel, in which the WTRU is configured with a 2 port codebook for both panels.

In another example, the WTRU may receive an indication of whether the WTRU may receive one or more TPMIs for its uplink transmission. For example, the WTRU may receive this indication based on receiving a configuration(s) with multiple panels. In one or more cases, the WTRU may apply the indicated TPMI across panels, in which, for example, a single TPMI indication is applied. For example, the WTRU may receive and apply a TPMI for an N layer transmission, in which x layers are mapped on a first panel, and N-x layers are mapped on a second panel. In another example, the WTRU may receive and apply an indication of N antenna ports mapped on a first panel, and N-x antenna ports mapped on a second panel. The WTRU may receive an indication to determine x. In some cases, the WTRU may determine x based on a configured codebook for each panel. In other cases, the WTRU may extend the DCI fields for antenna port indication by a single bit to distinguish the indicated ports for each panel.

The WTRU may receive one or more SRI and/or TPMI that indicate the number of layers per panel. The maximum number of total layers may be fixed. The max number of total layers may be based on the WTRU's reported capability. In one or more other cases, a first TPMI may indicate the number of layers N. The WTRU may be configured with a number of layers L (e.g., a maximum number). The WTRU may determine the second TPMI from a subset of the TPMI codebook. For example, the WTRU may determine the second TPMI from a subset of the TPMI codebook, such that TPMIs with N-L layers may be considered. In one or more cases, the WTRU may be configured with a codebook subset for SMP (e.g., SMPtxMode). The codebook subset may include a subset of TPMIs. The subset of TMPIs may be from a set of precoders (e.g., a whole set of precoders). The WTRU may determine that one or more TPMI indices received in a grant may be mapped to a codebook subset corresponding to SMP.

The WTRU may receive a single DCI containing two TPMIs/SRIs for PUSCH repetition (TDM). For example, in a single DCI multi-TRP operation (e.g., a transmission on a same number of layers), the WTRU may receive a single DCI containing the two TPMIs/SRIs. The WTRU, configured with SMP mode, may be configured to receive scheduling for an uplink transmission using a same or a different number of layers. In one or more cases, the WTRU may use one or more of the following. For instance, the WTRU may receive an indication to determine whether it is in a SMP or non-SMP mode, and an indication containing precoding and rank information. In another instance, the WTRU may receive a single dynamic indication. In another instance, a multi-panel WTRU configured for multi-TRP transmission may receive a DCI with an enhanced capability to divert transmission from any panel to any TRP. In another instance, the WTRU may receive an enhanced TDRA table, in which the WTRU may be configured with a mapping of SRIs and TPMIs to PUSCH repetitions or transmission.

The WTRU may receive a first indication to determine whether the first indication is in a SMP or non-SMP mode. The WTRU may receive a second indication containing precoding and rank information. In an example, the WTRU may receive a MAC CE or a DCI as the first indication to determine SMP or non-SMP mode. In another example, the WTRU may receive an RRC configuration to either SMP or non-SMP mode. In another example, the WTRU may receive and interpret indications (e.g., the second indication) to determine precoding and other scheduling information for each panel. For instance, the WTRU may receive and interpret the indications once the WTRU determines the SMP mode.

The WTRU may receive a single dynamic indication, e.g., a DCI. For example, the single dynamic indication may contain the SMP mode determination, precoding information, and other scheduling information for each panel. In one or more cases, the WTRU may receive an explicit or implicit indication for identifying the SMP mode. For example, the WTRU may receive a DCI containing an explicit indication, e.g., a flag, indicating the SMP mode. In another example, the WTRU may be configured with one or more reference signals designated for SMP or non-SMP mode of operation. The WTRU may determine the SMP mode by determining whether a configured reference signal, e.g., an indicated SRI, belongs to the set. In another example, the WTRU may receive an implicit indication to identify the SMP mode.

The WTRU may be a multi-panel WTRU configured for multi-TRP transmission. The multi-panel WTRU may receive a DCI with the capability to divert transmission from any panel to any TRP. The enhancement of the DCI may be based on the addition of a single bit to the existing TPMI fields for PUSCH repetition. In an example, the addition of the single bit may be explicit. For instance, the addition of the single bit may be explicit by direct addition of the bit to the TPMI field. In another example, the addition of the bit that signifies and distinguishes the SMP panel may be implicit. For instance, an implicit association of SMP mode and a panel involved may be based on an indicated SRI. For example, the WTRU may receive a specific range of SRIs for SMP. A first subset of range may be for implicit indication of a first panel. A second subset of range may be for implicit indication of a second panel. In another example, the WTRU may receive a linkage of SRIs for SMP. The WTRU may determine to transmit in SMP mode as a function of a grant containing two linked SRIs. The WTRU may receive the linkage as part of the SRS resource configuration. SRS resource or resource set IDs (e.g., different SRS resource or resource set IDs) may be linked for an SMP mode of operation. In another example, the WTRU may identify linked SRIs based on a semi-static configuration (e.g., RRC). Alternatively or in conjunction, the WTRU may receive a MAC-CE which includes activation commands or deactivation commands for different SRI pairs. The WTRU may indicate one or more preferred SRI pairs in, for example, a CSI report for SMP or a MAC-CE. The WTRU may explicitly indicate an SMP flag along with the preferred pair (e.g., SRI1 and SRI2).

The WTRU may receive three bits. The first bit may indicate the panel. The remaining bits may indicate the intended recipient TRP and/or ordering of panels/TRPs. For example, the WTRU may receive the enhanced DCI and determine the received indication as follows: 000 sTRP1; 001 sTRP2; 010 TRP1-TRP2; 011 TRP2-TRP1; 100 SMP (e.g., panel 1 TRP1; and panel 2 TRP2); and 101 SMP (e.g., panel 2 TRP1; and panel 1 TRP2).

The WTRU may receive a TDRA table (e.g., an enhanced TDRA table). For example, the WTRU may receive the TDRA table, in which the WTRU is configured with a mapping of SRIs and TPMIs to PUSCH repetitions or transmission. For example, the TDRA may include a “SMP” mapping type flag. The TDRA may include the SMP mapping type flag, in which the WTRU may determine that a 0 indicates to transmit PUSCH in a non SMP manner and a 1 indicates to transmit the PUSCH in SMP. The WTRU may determine the mapping of repetitions to panel as a function of the SMP mode of operation. In some cases, the WTRU may determine a mapping of repetitions to panels. The WTRU may determine the mapping of repetitions to panels when the WTRU transmits more than two repetitions. The WTRU may determine the mapping of repetitions to panels based on a preconfigured mapping. In one or more cases, when the WTRU transmits more than two repetitions, the WTRU may determine the mapping of repetitions to panels based on a preconfigured mapping. For example, the WTRU may determine in a non SMP mode to transmit four repetitions in time instances t1, t2, t3, t4. In SMP mode, the WTRU may transmit repetitions 1 and 2 in time instance t1 on panel 1, and repetitions 3 and 4 in time instance t2 on panel 2. TDRA may include a PUSCH mapping type (e.g., a new PUSCH mapping type) for SMP other than mapping type A or B. The WTRU may determine from the mapping type an association between a K2 offset. The WTRU may determine from the mapping type an association between the K2 offset, in which more than one PUSCH transmission may be mapped to the same K2 offset. The K2 offset may be the offset from a DCI to a PUSCH transmission.

The WTRU may determine a Redundancy Version (RV) mapping for SMP mode of operation. The WTRU may map a pair of RV values for each time instance with a SMP PUSCH transmission. The WTRU may determine a default SMP configuration when scheduled in a SMP mode. For example, for the cases in which the WTRU does not receive a TDRA, the WTRU may assume a default SMP configuration when scheduled in the SMP mode. A WTRU may determine a default configuration, which may include sending a repeated PUSCH on both panels.

The WTRU may transmit a msgA PUSCH using SMP. The WTRU may indicate SMP through a preamble selection. The WTRU may transmit a msgA PUSCH using SMP. The WTRU may indicate the SMP mode of operation, for example, as a function of the preamble index. The WTRU may use a two-step RACH procedure. The WTRU may select and initiate transmission of a preamble from a pool of preamble indices. For example, in a two-step RACH procedure, the WTRU may select and initiate transmission of a preamble from a pool of preamble indices. The WTRU may transmit on a PUSCH resource that is linked to the preamble index (e.g., the selected preamble index). The PUSCH may be defined as the msgA PUSCH. The WTRU may indicate that the SMP is used for a msgA PUSCH through the preamble selection. The WTRU may partition the preamble subsets. For example, the WTRU may partition the preamble subsets into a subset of preamble for single panel transmission of msgA PUSCH and a second set of preambles for SMP transmission of msgA PUSCH. The WTRU may map the msgA PUSCH to both panels and transmit both panels simultaneously. For example, for the cases in which the WTRU selects the SMP preamble, the WTRU maps the msgA PUSCH to both panels and transmit both panels simultaneously. A receiver may decode the preamble of msgA. The receiver may determine the decoded preamble belongs to a set of preambles for SMP. The receiver may expect to an receive an SMP msgA transmission.

The WTRU may determine a subset and/or patterns of antenna panels for SMP PUSCH transmission. As described herein, the WTRU may receive bits (e.g., new bits) in the DCI. The bits may indicate to dynamically switch between non-SMP and SMP modes of operation. The WTRU may have one or more modes of operation (e.g., multi-panel modes of operation) based on antenna panels being active.

For example, in a mode of operation (e.g., non-SMP1), the WTRU may transmit from a single antenna panel at a given time. For instance, the WTRU may transmit from the single antenna panel, in which the antenna panel may include one or more of a panel index, a group of antenna elements, or group of antenna ports. In one or more cases, the WTRU may have multiple antenna panels. For example, the WTRU may have multiple antenna panels in the non-SMP1 mode, in which one antenna panel is active. The active antenna panel may be an antenna panel in which the WTRU receives (e.g., SSB, CSI-RS, TRS, DM-RS) or transmits (e.g., SRS, DMRS) reference signals for the purpose of channel tracking or measurement. The WTRU may be scheduled to transmit on the one active antenna panel in the non-SMP1 mode. In some cases, the WTRU may report (e.g., in a CSI report) the index of the active panel. In other cases, the WTRU may receive a control message from a network to indicate the active panel. The control message may include, for example, but not limited to, a MAC-CE containing the index of the panel to activate, or RRC reconfiguration. The WTRU may respond to the control message by sending a message to the network with the requested information.

In another example, in a second mode of operation (e.g., non-SMP2), the WTRU may have more than one active antenna panel. For instance, the WTRU may transmit, in, for example, the non-SMP2 mode, from one antenna panel at a time. The WTRU may receive DCI to schedule a PUSCH dynamically from an active panel (e.g., any active panel). In some cases, the WTRU may indicate the set of active antenna panels (e.g., in a CSI report). In other cases, the WTRU may receive a control message from a network to indicate the set of active panels. The control message may include, for example, but not limited to, a MAC-CE containing the index of the panels to activate or RRC reconfiguration. The WTRU may respond to the control message by sending a message to the network with the requested information.

In another example, in a third mode of operation (e.g., SMP or STxMP), the WTRU may have more than one active antenna panel. The WTRU may transmit, for example, in the SMP or STxMP mode, from more than one antenna panel in the same time slot. The WTRU may receive DCI or MAC-CE indicating a set of panels for SMP. In some cases, the WTRU may indicate the set of panels supported for STxMP in a CSI report. In some cases, the WTRU may indicate the set of panels supported for STxMP in an UL MAC-CE. The UL MAC-CE may indicate the panel indices. In other cases, the WTRU may receive a control message to indicate the panels for STxMP. The control message may include, for example, but not limited to, a MAC-CE which includes the index of the panels paired for STxMP or RRC reconfiguration. The WTRU may respond to the control message by sending a message to the network with the requested information.

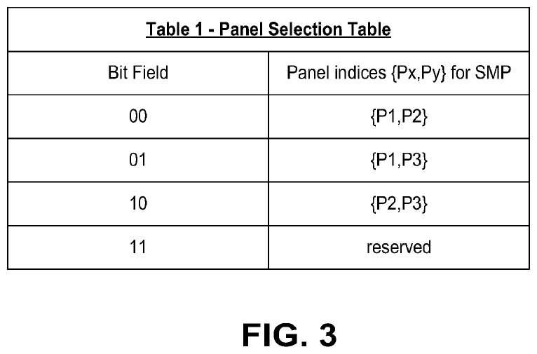

The WTRU may dynamically switch between modes of operation. For example, the WTRU may dynamically switch between different multi-panel modes of operation. The WTRU may receive, from a network, DCI having a set of bits indicating a mode of operation (e.g., an SMP mode of operation). The set of bits may indicate a panel index or indices for SMP. For example, the WTRU may report to a network a capability for a mode of operation (e.g., an SMP mode of operation) and/or a set of panel indices. The set of panel indices may indicate where the WTRU is scheduled for SMP (e.g., panels 1 and 2). The WTRU may determine a subset of panels used in SMP. The WTRU may determine a subset of panels used in SMP as a function of the bits received in the DCI from the network. For example, the WTRU may be equipped with 4 panels. The WTRU may report that the subset of panels 1, 2, or 3 may be used for SMP. The WTRU may receive a bit indicating SMP and a bit indicating to use panels (e.g., panels 1 and 2) for SMP. The WTRU may receive (e.g., via a RRC configuration) a panel selection table from a network. The table fields indicate the panel selection. For example, as illustrated in Table 1 of FIG. 3, the WTRU may include 3 panels indexed as P1, P2, and P3. For the cases in which the bit field received is, for example, 01, SRI1 and SRI2 refer to the SRS resource sets of P1 and P3, respectively. The WTRU may receive DCI scheduling a PUSCH and/or the DCI may include the bit field (e.g., 00) for panel selection, SRI1, and/or SRI2. The WTRU may determine to transmit a PUSCH with panels P1 and P2 in SMP, and a WTRU may determine that SRI1 and SRI2 refer to the SRS resource sets of P1 and P2, respectively. The WTRU may base this determination on the received DCI from the network.

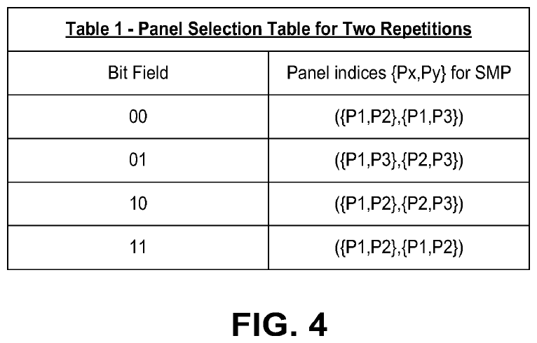

The WTRU may cycle through different panel index pairs in a predetermined pattern, based on a received panel selection table, and/or according to a repetition index. The WTRU may be configured, for example, by the network, with separate panel selection tables for a number of repetitions. The WTRU may receive a repetition index from a network in DCI (e.g., TDRA). For example, as illustrated in Table 2 of FIG. 4, a bit field and the corresponding panel indices for SMP for two repetitions are received by the WTRU from the network. For instance, for the cases in which the bit field 00 is received, the WTRU transmits using panels {P1, P2} on the first repetition and {P1, P3} on the second repetition. In another instance, for the cases in which the bit field is 11, the WTRU transmits using {P1, P2} on both repetitions. In some cases, the WTRU may receive one of the patterns preconfigured through RRC. In some cases, the WTRU may receive a MAC-CE activating one of the patterns through MAC-CE. In some cases, the WTRU may receive a bit field in a DCI scheduling a PUSCH.

In one or more cases, the WTRU may determine the antenna port mapping based on the STxMP mode of operation. For example, the WTRU may receive a DCI scheduling a PUSCH with a field for antenna port indication. The WTRU may determine the table based on one or more of a rank (e.g., 1 to 4), transform precoder (e.g., DFT or CP OFDM), or a DMRS type and configuration. The WTRU may transmit the PUSCH with the DMRS ports. The WTRU may rate match around DMRS CDM groups as indicated by the antenna port indicator.

The WTRU may determine an antenna port table based on the SMP mode of operation. For instance, the WTRU may determine an antenna port table having an antenna port configuration based on the SMP mode of operation. The antenna port table may be, for example, a new antenna port table or an existing antenna port table. The WTRU may determine an association between a panel and the antenna port indication based on the DCI fields (e.g., the received DCI fields). For example, the WTRU may determine to use Table 1 of FIG. 2 for the cases in which the WTRU receives a non-SMP mode of operation. In an example, the mode of operation may be dynamically indicated in a DCI or configured through MAC-CE. In some cases, the WTRU may receive bits indicating an SMP mode of operation. For example, the ordering of SRIs in the DCI may be a first SRI from SRS resource set 1 or panel 1, and a second SRI from SRS resource set 2 or panel 2. Based on the ordering of SRIs in the DCI, the WTRU may determine that the first port (e.g., 0) is associated to panel 1, and the second port is associated to panel 2 (e.g., 1). The antenna ports may be split evenly or non-evenly between panels (e.g., for other tables in which the rank indication is larger than 2). For example, based on the SRS resource rank, the WTRU may determine the number of ports per panel. For instance, a first SRI may indicate an SRS resource with rank 1, and a second SRI may indicate an SRS resource with rank 2. The WTRU may associate one port (e.g., port 0) to the first panel indicated by the first SRI. The WTRU may associate two ports (e.g., ports 1 and 2) to the second panel indicated by the second SRI.

The WTRU may use an SRS resource set indicator to determine a SMP mode of operation with an association to the antenna port indication. For example, the WTRU may receive one or more of a DCI with two SRSs (e.g., SRI1 and SRI2), one or more bits (e.g., a new bit) indicating a SMP mode of operation, and an SRS resource set indicator. For example, for the cases in which the SMP mode of operation indicates non-SMP, the SRS resource set indicator indicates legacy operation. For instance, 01 and 11 indicates the ordering of SRIs matched to repetitions. For an indicated SMP mode of operation, for the cases in which an SRS resource set indicator of 00 is received, the WTRU determines to use SRI1 on panel 1 (e.g., non-SMP2 panel 1). For the cases in which an SRS resource set indicator of 01 is received for an indicated SMP mode of operation, the WTRU determines to use SRI2 on panel 2 (e.g., non-SMP2 panel 2). For the cases in which an SRS resource set indicator of 10 is received for an indicated SMP mode of operation, the WTRU determines to use SRI1 and SRI2, in which SRI1 corresponds to panel 1 and SRI2 corresponds to panel 2 (SMP). For the cases in which an SRS resource set indicator of 11 is received for an indicated SMP mode of operation, the WTRU determines SRI1 corresponds to panel 1 and SRI2 corresponds to panel 3 (SMP).

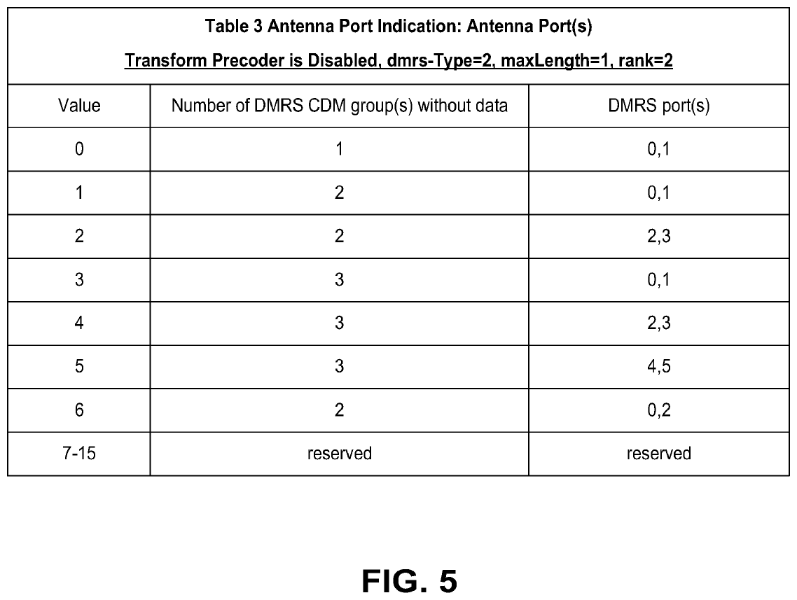

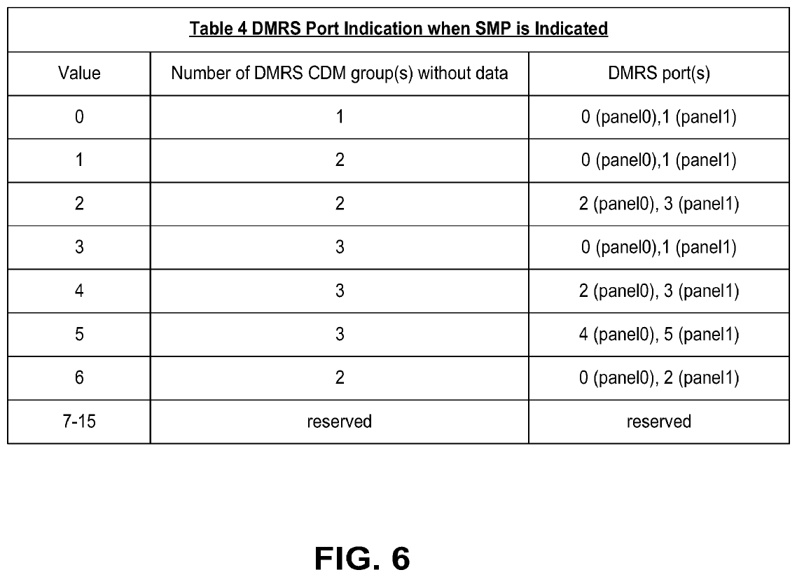

The WTRU may use a legacy table, such as Table 3 illustrated in FIG. 5, when the DCI indicates non-SMP mode of operation. The DCI may indicate the non-SMP mode of operation through, for example, a SRS resource set indicator and/or a bit field for SMP. In one or more cases, the WTRU may use a table, such as Table 4 illustrated in FIG. 6, when the DCI indicates a SMP mode of operation.

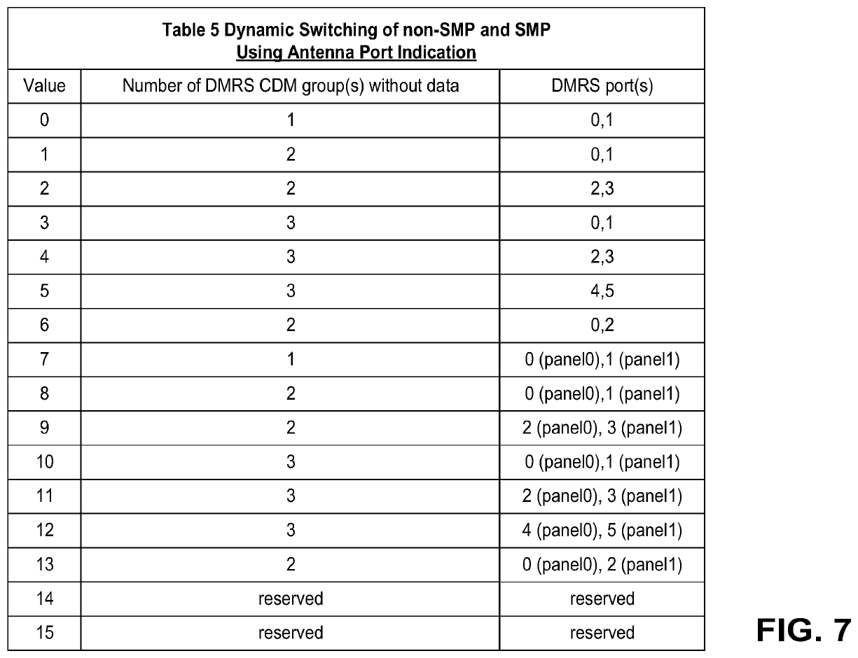

The WTRU may be configured to determine antenna port mapping and/or SMP mode of operation. For example, the WTRU may determine antenna port mapping and/or SMP mode of operation based on the antenna port indication. The WTRU may determine an antenna port mapping table (e.g., a new antenna port mapping table) for a SMP operation. The antenna port mapping table may indicate either a SMP or non-SMP mode of operation. For example, the WTRU may determine to transmit in SMP or non-SMP mode of operation based on, for example, Table 5 of FIG. 7 that illustrates an example of a SMP antenna ports table. In an example, any value greater than or equal to 7 corresponds to an SMP mode in which two antenna ports are used and associated to different panels. In an example, if a value of 0 is indicated, the WTRU transmits PUSCH with DMRS ports 0 and 1 on a single antenna panel, In another example, if a value of 7 is indicated, the WTRU transmits PUSCH with DMRS ports 0 and 1 on panels 0 and 1, respectively. In one or more cases, when a single panel is indicated, the WTRU may use a single PUSCH scrambling identity. In one or more cases, when two panels are indicated, the WTRU may use two PUSCH scrambling identities.

The WTRU may receive, e.g., from a gNB, one or more PUSCH-scrambling parameters. The PUSCH-scrambling parameters may be, for example, but not limited to, PUSCH-related sequence initialization parameters, datascramblingidentityPUSCH values, and the like. The WTRU may use the PUSCH-scrambling parameters for transmission of a PUSCH. For example, the WTRU may use the PUSCH-scrambling parameters for transmission of the PUSCH, for example, for inter-cell and/or inter-WTRU/TRP UL interference randomization/mitigation. It is noted that the examples provided herein relate to the one or more PUSCH-scrambling parameters including a first one for TRP1 and/or WTRU-panel1 and a second one for TRP2 and/or WTRU-panel2. However, it is understood that the examples provided herein may apply to more than 2 TRPs and/or more than 2 WTRU-panels considered/applied for communication between the gNB (e.g., the gNB employing at least TRP1 and TRP2) and the WTRU (e.g., the WTRU employing/using at least the WTRU-panel1 and the WTRU-panel2). One of the TRPs may be, for example, the primary TRP (e.g., TRP1).

The WTRU may receive an indication/configuration that a scrambling ID (e.g., a first scrambling ID) of one or more PUSCH-scrambling parameters may be used/applied for TRP1. For example, the scrambling ID of one or more PUSCH-scrambling parameters may be used/applied for TRP1 associated with a first CORESETpool index or a first TRP-indicator, and/or WTRU-panel1. The WTRU may receive an indication/configuration that a second scrambling ID of the one or more PUSCH-scrambling parameters may be used/applied for TRP2. For example, the second scrambling ID of the one or more PUSCH-scrambling parameters may be used/applied for TRP2 associated with a second CORESETpool index or a second TRP-indicator, and/or WTRU-panel2.

The WTRU may (be configured to) apply/use the scrambling ID (e.g., the first or second scrambling IDs) for transmission of a PUSCH. For example, the WTRU may apply/use the scrambling ID for transmission of the PUSCH when the PUSCH is scheduled to be transmitted toward TRP1 or TRP2. The WTRU may apply/use the scrambling ID for transmission of the PUSCH based on, for example, determining that at least one or more of the following conditions is satisfied.

A first condition to apply/use the scrambling ID may include receiving a DCI including a scheduling grant for the PUSCH. The DCI including a scheduling grant for the PUSCH may be received via (e.g., based on) a CORESET being associated with TRP1 or TRP2. For example, the CORESET may be associated with TRP1 or TRP2 based on one or more of a CORESETpoolIndex value, a TRP-indicator, and the like.

A second condition to apply/use the scrambling ID may correspond to receiving a beam/TCI indication associated with TRP1 or TRP2 for the scheduled PUSCH. The beam/TCI indication may be associated with TRP1 or TRP2 for the scheduled PUSCH, for example, by a UL-TCI state, by an SRS resource indicator (SRI), by a unified TCI applicable for multiple channels/signals, or by an individual/direct beam/TCI-state indicated for the PUSCH. For example, the WTRU may receive an mTRP-UL-TCI with more than one (unified) TCI state. The TCI state may be, for example, a unified TCI state. The WTRU may determine (or receive an indication) that each TCI of the more than one TCI may be associated with each PUSCH scrambling ID (e.g., for each TRP). In another example, the WTRU may receive a grant with two SRIs belonging to two SRS resource sets. The WTRU may apply a first scrambling identity to the SRI from the first resource set, and a second scrambling identity to the transmission with the SRI from the second resource set.

A third condition to apply/use the a scrambling ID may correspond to on receiving an indication/configuration of a semi-static selection of a scrambling ID. For example, the WTRU may receive an RRC configuration that a PUSCH scrambling ID is associated with a respective TRP and/or based on receiving an indication to update/activate a scrambling ID to be associated with which TRP. The PUSCH scrambling ID may be associated with a respective TRP based on a fixed associate rule. The WTRU may receive the indication to update/activate a scrambling ID via, for example, a MAC-CE.

A fourth condition to apply/use the scrambling ID may be based on receiving a dynamic indication (e.g., by a DCI) of a scrambling ID for PUSCH per TRP. The WTRU may receive the dynamic indication, for example, by a DCI. The WTRU may receive the dynamic indication of the scrambling ID for PUSCH per TRP, for example, for interference randomization. In an example, the WTRU may receive DCI1 including a first field, and individually, DCI2 including a second field. The first field may be, for example, a DMRS-related field. The second field may be, for example, a DMRS-related field. The DCI1 including the first field may indicate the first scrambling ID for TRP1. The DCI2 including the second field may indicate the second scrambling ID for TRP2. In another example, the WTRU may receive a DCI including a field (e.g., DMRS-related field) including a codepoint. The codepoint may be associated with an SMP mode/parameter. The codepoint may indicate that the WTRU applies the first scrambling ID for a first set of layer(s)/port(s) (e.g., transmitted from WTRU-panel1) of a PUSCH and the second scrambling ID for a second set of layer(s)/port(s) (e.g., transmitted from WTRU-panel1) of the PUSCH. The first set of layer(s)/port(s) may be, for example, transmitted from WTRU-panel1. The second set of layer(s)/port(s), may be, for example, transmitted from WTRU-panel1. The scheduled PUSCH is received at TRP1 and TRP2. The scheduled PUSCH is received at TRP1 and TRP2 based on the layer/port-domain separation of the PUSCH. The layer/port-domain separation of the PUSCH may be, for example, a “layer/port-domain separated” SMP-PUSCH. In an example, the DMRS layer/port indication for SMP may be based on one or more codepoints in a DMRS-related field of the DCI. One or more reserved codepoints of the DMRS-related field may be reused to indicate SMP ports. The WTRU may determine a PUSCH scrambling ID. For example, the WTRU may determine the PUSCH scrambling ID based on receiving the DMRS-related field. The DMRS-related field may include, for example, the indication of SMP ports. The DMRS-related field may include the indication of SMP ports as a function of antenna port(s) indicated by a codepoint of the one or more codepoints.

The WTRU may receive an explicit or implicit indication, for example, by a DCI. The indication may indicate whether a scrambling ID of the one or more PUSCH-scrambling parameters is to be applied or not to be applied for a scheduled PUSCH. The scrambling ID may, for example, be associated with a TRP.

The WTRU may receive a DCI, such as, a second DCI. The received second DCI may schedule a PUSCH to be transmitted toward TRP2. The WTRU may use the received DCI to schedule the PUSCH to be transmitted toward TRP2. The second DCI scheduling the PUSCH to be transmitted toward TRP2 may be based on one or more of a CORESETpoolIndex value of a CORESET via which the second DCI is received, a TRP-indicator, a beam/TCI indication for the PUSCH, WTRU-panel ID, and the like. The WTRU may determine that the DCI (e.g., second DCI) includes the explicit or implicit indication to apply the scrambling ID to the PUSCH. The indication to apply the scrambling ID to the PUSCH may be, for example, for the purpose of interference randomization. The WTRU may transmit the PUSCH based on applying the scrambling ID to the PUSCH. For example, in response to determining that the second DCI includes the indication of applying the scrambling ID, the WTRU transmits the PUSCH based on applying the scrambling ID to the PUSCH.

The WTRU may receive a DCI (e.g., a third DCI) scheduling a PUSCH (e.g., a third PUSCH) to be transmitted toward TRP2. The WTRU may determine that the DCI (e.g., third DCI) includes the explicit or implicit indication to NOT apply the scrambling ID to the PUSCH (e.g., third PUSCH). For example, the WTRU may determine that the third DCI includes the indication to not apply the scrambling ID to the third PUSCH based on, for example a network's efficient strategy of interference management that having an orthogonal DMRS port assignment for the PUSCH (without applying the scrambling ID) is preferred, instead of applying the scrambling ID for having interference randomization effects. The WTRU may transmit the PUSCH without applying the scrambling ID to the PUSCH. For example, the WTRU may transmit the PUSCH without applying the scrambling ID to the PUSCH in response to determining the DCI includes the indication to not apply the scrambling ID to the PUSCH.

Applying a scrambling ID to a PUSCH for a WTRU (or for a WTRU-panel) or not applying the scrambling ID, which may be determined dynamically (e.g., by a DCI), may provide advantages in terms of UL interference mitigation and/or performance improvement, in that there may be a (performance) trade-off between the following. For instance, there may be performance improvement in ensuring DMRS port orthogonality among the WTRU and other WTRU(s) (or among the WTRU-panel and other WTRU panel(s) of the same WTRU) in a cell/TRP (or across cell/TRP) without applying a scrambling ID to the PUSCH (e.g., when a high correlation between the WTRU-panels are observed/determined/considered in scheduling the PUSCH). In another instance, there may be performance improvement in applying the scrambling ID to the PUSCH for the purpose of having interference randomization effects (e.g., when a low correlation (in terms of beam directions) between the WTRU-panels are observed/determined/considered in scheduling the PUSCH, (e.g., where the DMRS port orthogonality may not be a dominant factor due to the beam domain separation between the WTRU-panels). The advantages may be achieved instead of having stringent DMRS port orthogonality. The WTRU may receive a grant (e.g., DCI) for transmission of a PUSCH, where a dynamic indication of applying a scrambling on the PUSCH with the scrambling ID or not applying the scrambling may be received based on (e.g., in relation to) the grant, (e.g., where the PUSCH is to be transmitted toward multiple TRPs (e.g., as SMP-PUSCH) or to be transmitted toward a single (selected) TRP (e.g., as a non-SMP-PUSCH)). The WTRU may receive the grant for transmission of a PUSCH based on considering the above advantages/trade-offs.

In one or more cases, for a msgA PUSCH, the WTRU may determine to use scrambling identities (e.g., two scrambling identifies) as a function of the preamble index. A subset of preamble indices may be associated to two different scrambling identities. The WTRU may initiate a msgA transmission using a preamble from this subset. The WTRU may determine a pair of scrambling identities. The WTRU may use one scrambling identity per panel from the pair.

The WTRU may initiate the RACH procedure by selecting a preamble index and/or transmitting a msgA preamble and PUSCH using the resources allocated for the preamble index for 2-step RACH. In one or more other cases, in 4-step RACH, the WTRU may select a preamble and transmits the preamble (e.g., msg1). The WTRU may receive a response from the network containing a grant (e.g., msg2). The WTRU may transmit a request using the allocated grant (e.g., msg3). The WTRU may receive a contention resolution from the network (e.g., msg4).

The WTRU may transmit a msgA PUSCH or msg3 in SMP mode of operation. The WTRU may transmit a msgA PUSCH or msg3 in SMP mode of operation by, for example, selecting a preamble from a subset of preambles associated to SMP. For example, preambles 1 to N may be associated to SMP. For the cases in which the WTRU transmits a preamble with an index 1<=n<=N, the WTRU may transmit the msgA PUSCH or msg3 in SMP. The WTRU may use a default configuration of SMP panels for msgA PUSCH or msg3 that is preconfigured. For example, the default configuration of SMP panels may include panels 1 and 2 being used for SMP of msgA with SRI1 and SRI2. In some cases, for each panel, the WTRU may associate the scrambling identities (e.g., panel 1 scrambling identity 1, and panel 2 scrambling identity 2) to a panel index. In other cases, the WTRU may receive the msg2 grant, which includes an indication of SMP mode of operation and associated parameters.

The WTRU with multiple panels may be able to adjust its power per panel. The WTRU may use different transmit powers as a function of the panel and/or TRP targeted by the UL transmission. The WTRU may adjust its power per panel since the pathloss towards a TRP may differ from another TRP.

The WTRU grant may include sets (e.g., two) of power control parameters. The sets of power control parameters may be, for example, open and closed loop commands, such as alpha, P0, and TPC. The power control parameters may be determined per TRP and/or with TDM'd transmissions. The WTRU may implement two power control loops and/or scaling rules according to EIRP limit per UL spatial filter (e.g., beam) and/or TotRadPw (total radiated power). The WTRU may use two simultaneous transmissions over two different panels to implement two power control loops and/or scaling rules.

Power classes may be determined for different form factors. Power classes may be defined in terms of, for example, but not limited to, one or more of the EIRP, TotRadPw, spherical coverage, and the like. In some cases, the WTRU may use a single beam transmission. In some cases, the WTRU may use two beams and two panels for simultaneous transmissions. For the cases in which the WTRU may use two beams and two panels for simultaneous transmissions, the WTRU may use one or more scaling rules for a specified TotRadPw limit. A WTRU panel may be rated as full EIRP power capable and/or TotRadPw limit compliant. As such, the WTRU may use one or more scaling rules to comply with a specified TotRadPw limit as each panel may be rated as full EIRP power capable, and thus TotRadPw limit compliant. In other cases, the WTRU may determine scaling rules based on hardware limitations at the WTRU (e.g., power limit per panel). The allocated power may be different if the UL grant is different (e.g., throughput case) versus a same UL grant (e.g., reliability case), based on the pathloss to each TRP. For example, even with substantially the same pathloss to each TRP, allocated power may be different if the UL grant is different versus the same UL grant.

The primary TRP or pTRP may be the cell broadcasting SSBs. Other TRPs may be referred to as secondary TRPs or aTRPs. Secondary TRPs may be added to the configuration. A pTRP and an aTRP may be served by different panels. A TRP may receive an outer loop (OL) set of parameters. The OL set of parameters may be different for each TRP. The OL set of parameters may be associated with antenna ports or SRI. Examples are described herein with reference to power control for PUSCH. It is be appreciated that the power control description may apply to SRS and/or PUCCH transmissions.

The UL grant for each TRP may be substantially the same. For example, Pcmax_panel1=Pcmax_panel2=Pcmax_panel. This may apply where there is the same RB and MCS allocations without P-MPR cases. This may provide reliability of power control for the WTRU.

The WTRU may start the power allocation for the pTRP. The WTRU may evaluate the power allocation against a Pcmax_panel. Pcmax_panel may be determined or a stored value. The WTRU may consider EIRP_panel1 and TotRadPw_panel1. The WTRU may determine whether Pcmax_panel is exceeded by an allocated power on pTRP. A WTRU may scale the power allocation for the pTRP and/or aTRP based on comparing EIRP_panel1 and TotRadPw_panel1 to Pcmax_panel. For example, the WTRU may lower the aTRP transmission (e.g., due to lack of power resources). In another example, for the cases in which allocated power on pTRP exceeds Pcmax_panel, the WTRU may scale accordingly, for example, by dropping the aTRP transmission by lack of power resources.

The WTRU may perform power allocation for panel2. The WTRU may verify the TotRadPw per WTRU from both panels. A WTRU having 2 panels may provide spherical coverage in a composite mode. That is, each panel may have 50% of the sphere. The TotRadPw may be split in two spatial regions. The TotRadPw may be an additive quantity. The TotRadPw may lead to independent EIRPs levels having their own EIRP limits. A global TotRadPw may be a limit (e.g., for simultaneous UL transmissions). In one or more other cases, the WTRU panels may have individual EIRP thresholds. The EIRP thresholds may be less than Pcmax_panel for the associated TotRadPw on the spherical coverage. The scaling may occur based on the TotRadPw per WTRU and on aTRP related panel. For example, when simultaneous transmissions occur, the scaling may occur based on the TotRadPw per WTRU and on aTRP related panel (e.g., only on the aTRP related panel.

The WTRU may have UL grants for pTRP and aTRP, which may be different. That is, RB and MCS are different and may be subject to one or more independent link adaptation procedures. This may apply throughput power control. The WTRU may start its power allocation by comparing a pTRP UL grant against a corresponding Pcmax_panel1. The WTRU may determine the power allocation for aTRP UL grant corresponding to a Pcmax_panel2. The WTRU panel may be subject to the EIRP generic power class limit per panel. As each panel is subject to the EIRP generic power class limit per panel, the WTRU may verify its power limits against the TotRadPw per WTRU limit, as follows:

TotRadPw_panel1+TotRadPw_panel2<=TotRadPw

If the WTRU determines that the above equation is not satisfied, the WTRU may perform a scaling operation to comply with the TotRadPw limit per WTRU. The scaling may be performed based on one or more of the following rules or priorities: (i) the PUCCH with ACK/NACK has a higher priority than PUCCH with CSI; (ii) the PUSCH with UCI has a higher priority than PUSCH without UCI; (iii) the PUSCH+PUSCH without UCI or CSI may lead to pTRP transmission priority; (iv) for the cases in which P-MPR is applied to a panel transmission, the other panel may receive power allocation priority; (v) the WTRU may determine that a codeword (e.g., one codeword) has a higher priority than the other codeword (e.g., where codeword 1 is transmitted on panel 1 and codeword 2 on panel 2); and (vi) the WTRU may determine that two PUSCH transmissions are intended for different traffic types with different reliability requirements. The WTRU may determine that two PUSCH transmissions are intended for different traffic types with different reliability requirements, such as, one PUSCH is for high reliability (e.g., URLLC) and a second PUSCH for high throughput (e.g., eMBB). The WTRU may apply a scaling factor, for example, to the high throughput transmission.

The WTRU may determine to use single panel transmission. For example, the WTRU may determine to use single panel transmission for the cases in which the scaling factor applied is greater than a threshold. In some cases, the WTRU may receive a threshold for the scaling as part of the SMP power control configuration. In other cases, the WTRU may receive a threshold for the scaling as part of the per TRP power control configuration (e.g., SRI power control). The WTRU may store the threshold in memory. The threshold may be a stored WTRU parameter. The WTRU may apply the threshold per panel. For example, the WTRU may apply the threshold per panel such that the WTRU may drop, for example, panel 1 if the scaling applied to panel 1 is greater than a threshold. The WTRU may transmit on panel 2. In other cases, the WTRU may transmit (e.g., only transmit) from the panel with the smallest scaling factor applied. For example, for the cases in which the WTRU determines to apply a scaling factor a1 and a2 to panel 1 and panel 2, respectively, and a1>a2>threshold, the WTRU may determine to transmit on panel 2 (e.g., only on panel 2). In some cases, the WTRU may include an indication of the scaled power to single panel in a PHR. The WTRU may include in the PHR a single PH value. The single PH value may implicitly indicate fallback to single panel transmission. In other cases, the WTRU may include an explicit flag indication of fallback to single panel transmission.

The scaling factor may be determined and/or applied per panel. For example, the WTRU may determine P1 as the power transmission for panel 1 based on the power control parameters for panel 1 and based on the power control algorithm. The WTRU may determine P2 as the power transmission for panel 2 based on the power control parameters for panel 2 and the power control algorithm. The WTRU may apply the scaling factor alpha as alpha*P1 when the WTRU determines that the scaling is to be performed for panel 1, and the WTRU may set its transmission power to alpha*P1.

The WTRU may receive a configuration that includes a set or codebook of power scaling factors (e.g., alpha values). For example, the WTRU may receive an indication that the WTRU may select an alpha from the set {0.5, 0.25, 0.1}. The WTRU may indicate the index of the alpha used (e.g., in a Power Headroom Report (PHR). The PHR may include additional bits to indicate the alpha index per PH value, and the index of the panel where the alpha is applied.

The WTRU may determine to apply the scaling factor alpha based on one or more thresholds. For example, the WTRU may receive a configuration with multiple alphas (e.g., {0.5, 0.25, 0.1}), and a set of power thresholds (e.g., {threshold1, threshold2, threshold3}). The WTRU may calculate delta=P1-P2. If delta>threshold1, the WTRU may select 0.5. If threshold1>=delta>threshold2, the WTRU may select 0.25. If threshold2>=delta, the WTRU may select 0.1. If threshold3>delta, the WTRU may apply no scaling factor.

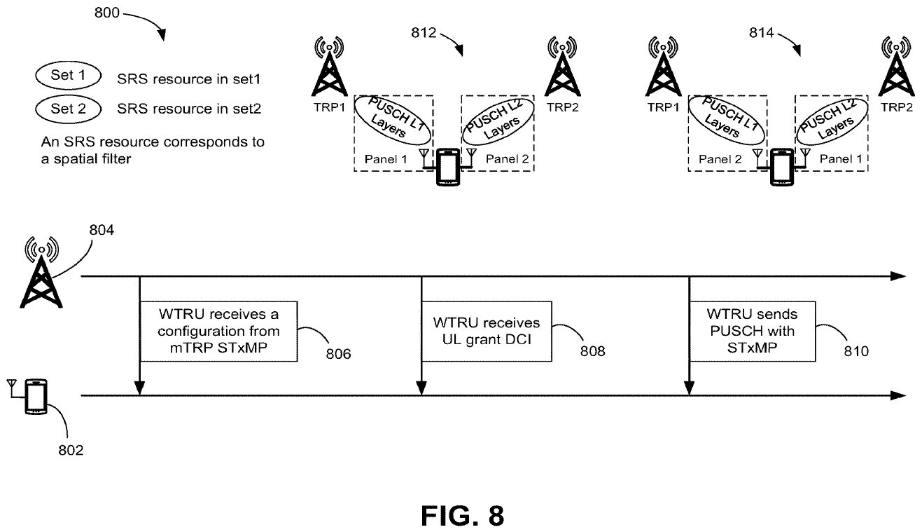

FIG. 8 is an example diagram 800 that illustrates a WTRU 802 and a network element 804 that are configured in accordance with an example configuration of the above described features. In the diagram 800, the WTRU 802 may receive a configuration for mTRP STxMP at 806. For example, the mTRP STxMP configuration may include a plurality of SRS resource sets (e.g., one for each TRP) each including one or more SRS resources, and/or a plurality of PUSCH scrambling IDs (e.g., one for each of a plurality of panels). For instance, the mTRP STxMP configuration may include two SRS resource sets (e.g., one for each of two TRPs) each including one or more SRS resources, and two PUSCH scrambling IDs, one for each of a first panel and a second panel.

The WTRU 802 may include DCI at 808. The DCI may include an UL grant. The DCI may include a transmission mode indication that indicates either a single panel transmission or simultaneous multi-panel (STxMP) transmission. In some examples, the transmission mode indication may be one or more bits (e.g., additional bits in the DCI), such as 1 bit. For instance, the transmission mode indication may be provided via a DCI comprising three bits, as the most significant bit of 3 bits, for instance, by extending existing 2-bit SRS resource set indicator (SRSSI) in the DCI to 3-bits and repurpose the bits as described herein. The DCI may include an indication of which panel to use with each resource set (e.g., 1 bit: LSB of 3 bits when the indicated tx mode is STxMP). For example, the indication of which panel to use with each resource set may be provided via a 3-bit SRSSI, where when the first bit 0: single panel mode with release 17 options, 000: single TRP1, 001: single TRP2, 010: TDM TRP1-TRP2, 011: TDM TRP2-TRP1, and when the first bit 1: multi-panel mode is configured with STxMP options, such as 100: panel 1/2 with SRS resource set 1/2, 101: panel 1/2 with SRS resource set 2/1. The DCI may include an indication (e.g., via TPMI or SRI) of a precoder for one or more (e.g., each) layer, such as a first precoder and a first number of layers (L1) and a second precoder and a second number of layers (L2), where L1< >L2.

At 810, the WTRU may send PUSCH with STxMP in accordance with the configuration information (e.g., received at 806) and/or the DCI (e.g., received at 808). For example, based on the indication of which panel to use with each resource set, the WTRU may transmit a PUSCH transmission using (e.g., based on) the first panel via an SRS resource in the first set and using (e.g., based on) the second panel via an SRS resource in the second set (e.g., as shown in 812). Alternatively, based on the indication of which panel to use with each resource set, the WTRU may transmit a PUSCH transmission using (e.g., based on) the first panel via an SRS resource in the second set and using (e.g., based on) the 2nd panel via an SRS resource in the first set (e.g., as shown in 814). In some examples, the transmission using each panel uses scrambling based on an index of the respective panel and the respective scrambling ID and precoding (e.g., based on the respective TPMI or SRI in the DCI) is applied to the respective number of layers for each panel (e.g., L1 and L2 for the respective 1st and 2nd panels).

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A wireless transmit/receive unit (WTRU) comprising:
a processor configured to:
receive configuration information indicating a first sounding reference signal (SRS) resource set and a second SRS resource set;
receive first downlink control information (DCI) comprising a first UL grant, the first DCI comprising a first indication to transmit with multiple panels simultaneously, and a second indication associating each of the multiple panels with a respective one of the first or second SRS resource sets for the first UL grant, wherein the second indication indicates that:
the first SRS resource set is to be used for first transmission using a first panel and the second SRS resource set is to be used for a second transmission using a second panel, or
the second SRS resource set is to be used for the first transmission using the first panel and the first SRS resource set is to be used for the second transmission using the second panel; and
simultaneously transmit the first transmission via the first panel and the second transmission via the second panel, in accordance with the first and second indications.

2. The WTRU of claim 1, wherein the configuration information indicates a first scrambling ID associated with a first panel and a second scrambling ID associated with a second panel.

3. The WTRU of claim 2, wherein the first transmission using the first panel uses a first scrambling sequence determined based on an index of the first panel and the first scrambling ID, and the second transmission using the second panel uses a second scrambling sequence determined based on an index of the second panel and the second scrambling ID.

4. The WTRU of claim 3, wherein the first scrambling sequence is initialized with the index of the first panel, and the second scrambling sequence is initialized with the index of the second panel.

5. The WTRU of claim 3, wherein the first transmission using the first panel uses a first precoder based on a first number of layers associated with the first panel, and the second transmission using the second panel uses a second precoder based on a second number of layers associated with the second panel.

6. The WTRU of claim 1, wherein the first DCI further comprises a third indication associating a first precoder with a first number of layers and a second precoder with a second number of layers.

7. The WTRU of claim 1, wherein the first SRS resource set corresponds to a first spatial filter, and the second SRS resource set corresponds to a second spatial filter.

8. The WTRU of claim 1, wherein the processor is further configured to:
determine a power scaling factor to adjust the power allocation between the first panel and the second panel; and
apply the power scaling factor to adjust a power allocation between the first panel and the second panel.

9. A method comprising:
receiving configuration information indicating a first sounding reference signal (SRS) resource set and a second SRS resource set;
receiving first downlink control information (DCI) comprising a first UL grant, the first DCI comprising a first indication to transmit with multiple panels simultaneously, and a second indication associating each of the multiple panels with a respective one of the first or second SRS resource sets for the first UL grant, wherein the second indication indicates that:
the first SRS resource set is to be used for first transmission using a first panel and the second SRS resource set is to be used for a second transmission using a second panel, or
the second SRS resource set is to be used for the first transmission using the first panel and the first SRS resource set is to be used for the second transmission using the second panel; and
simultaneously transmitting the first transmission via the first panel and the second transmission via the second panel, in accordance with the first and second indications.

10. The method of claim 9, wherein the configuration information indicates a first scrambling ID associated with a first panel and a second scrambling ID associated with a second panel.

11. The method of claim 10, wherein the first transmission using the first panel uses a first scrambling sequence determined based on an index of the first panel and the first scrambling ID, and the second transmission using the second panel uses a second scrambling sequence determined based on an index of the second panel and the second scrambling ID.

12. The method of claim 11, wherein the first scrambling sequence is initialized with the index of the first panel, and the second scrambling sequence is initialized with the index of the second panel.

13. The method of claim 11, wherein the first transmission using the first panel uses a first precoder based on a first number of layers associated with the first panel, and the second transmission using the second panel uses a second precoder based on a second number of layers associated with the second panel.

14. The method of claim 9, wherein the first DCI further comprises a third indication associating a first precoder with a first number of layers and a second precoder with a second number of layers.

15. The method of claim 9, wherein the first SRS resource set corresponds to a first spatial filter, and the second SRS resource set corresponds to a second spatial filter.

16. The method of claim 9, further comprising:
determining a power scaling factor to adjust the power allocation between the first panel and the second panel; and
applying the power scaling factor to adjust a power allocation between the first panel and the second panel.
